(19) United States
(12) Patent Application Publication
(10) Pub. No.: US 2004/0226519 A1
(43) Pub. Date: Nov. 18, 2004

(54) Method of managing feed and diet for farm animals

(76) Inventors: Timothy Paul Doucette, Janesville, WI (US); Bernard Natt Codding, Milton, WI (US)

Correspondence Address: GODFREY & KAHN S.C., 780 NORTH WATER STREET, MILWAUKEE, WI, 53202, US

(21) Appl. No.: 10/773,984

(22) Filed: Feb. 6, 2004

Related U.S. Application Data
(63) Continuation of application No. PCT/US02/35001, filed on Oct. 31, 2002.
(60) Provisional application No. 60/335,972, filed on Oct. 31, 2001.

(51) Int. Cl. A01K 1/10; A01K 5/00

(52) U.S. Cl. 119/51.02

(57) ABSTRACT

A farm animal feed management system that can be used to order feed and adjust rations automatically. A local database transmits animal, production, and ration data for analysis by a service provider such as a nutritionist, veterinarian or feed supplier. The service provider can compare this data to other farms, and use such information to adjust rations, order feed or suggest examination by a veterinarian. Alternatively, the local database transmits the data to a first remote database that transmits the data to a service provider. Comparisons between farms and other data analysis can be done at the first remote database.

### CROSS-REFERENCE TO RELATED APPLICATION

This patent claims priority under 35 U.S.C. §119 to a provisional patent application, Serial No. 60/335,972, filed Oct. 31, 2001. The provisional application is hereby incorporated by reference.

### STATEMENT RELATING TO COPYRIGHTS

A portion of the disclosure of this patent document contains material that is subject to copyright protection. The copyright owner has no objection to the facsimile reproduction by anyone of the patent document or the patent disclosure as it appears in the Patent and Trademark Office patent file or records. The copyright owner does otherwise reserve all copyrights whatsoever.

### BACKGROUND OF THE INVENTION

This invention relates generally to a method for farm management, and more particularly to a method for managing animal feed supply for a prescribed diet. The system is implemented in computer hardware and software. This system is further implemented using two-way communication.

In a farm of the past, farmers obtained a supply of feed for farm animals. Animals were fed diet according to the type of feed available. In the latter part of the last century, agricultural technology improved the diet of farm animals. Today, farm animals may be fed diets that are specific to their needs and output. For instance, dairy cows are fed differently than beef cattle to affect the animal's milk or meat production. The product data obtained from the animal (i.e. percentage of butterfat in milk) can be correlated to the diet so that the latter may be adjusted accordingly. Thus, today's farmer records data that can show how a prescribed diet affects the final product. A farmer may then use this data to optimize that final product.

Further, data collected by farmers is used by nutritionists, feed suppliers, veterinarians or the like. The data is collected out in the field by a number of methods. One method involves sending the feed weight per herd to a farm computer via a memory card device or radio signal. This data and other information is collected onto a local computer database, preferably a database such as TMR TRACKER™, a software product available from Digi-Star, located in Fort Atkinson, Wis.

The local database or system is initially set up by entering relevant data into a computer. This computer is typically located at the farm from which data is collected. During the initial setup of the local database, the following data may be gathered:

a) listing of ration ingredients including the percentage of dry matter, amount in inventory, cost per unit weight, and supplier name;

b) diet information such as all rations/premixes, either by load percentage, dry weight, or unit weight per volume;

c) herd information including pen number, number of head per pen, feed ration, and number of feedings per day;

d) mixer information such as name, size and model number; and

e) mixer driver information such as name and identification number.

Once the above information is obtained, the data is stored in the local database. The input of this data may take place as follows, though not necessarily in the following order. Ingredient information is entered into the local database. Preferably, each feed ingredient is assigned a code. Each code will have a description and include the percentage of dry matter in the ingredient, amount of daily usage, the amount of the ingredient that signals a reorder, cost per unit weight, amount in inventory, reorder data and the current cost of the present inventory. Shrinkage information may be included if desired, and applied daily, weekly, monthly, or when received. Inventory information is adjusted when the shipment is received.

The rations/pre-mixes may be entered using any of the following bases: dry matter intake, actual weight or percentage load. Each ration is assigned a ration code that is displayed for the mixer driver/operator, preferably at a scale located on or connected to the mixer. A full description of each ration and the maximum amount of the ration that can be contained in the mixer is also entered into the database. Typically several ingredients will make up each ration, i.e. corn silage, corn, hay and the like. Premixes are added as ingredients within a ration.

Another item that is entered is pen information. This includes the pen type. Pen types refer to the animals held in the group, i.e. high producers, heifers, lame animals, etc.

Feeding data is also entered. This data includes pen number, description of pen, number of head in the pen, pen type, and feeding schedules. The feeding schedule is the ration-weight per head and feeding factor (percentage amount of feed, per feeding, per day). For example, if a pen is fed twice a day, the first feeding may be set to sixty percent, and the second to forty percent. Global feeding factors that affect all feeding may also be indicated. For instance, the total amount fed to a pen can be increased by a desired percentage value.

The mixer data is also entered for each feed mixer. This data includes the assigned mixer number, load volume, and a load description. The mixer status may be indicated as in use (active), not in use (inactive), or spare (verify).

Finally, data relating to the driver is entered, which may include the driver's name and a user code for that driver.

Once all of the data is entered, specific feed loads are preferably sent to an electronic memory storage device such as a memory card. The feed loads may be calculated per truck. For example, for a first feeding, truck number one may be available. This truck may be scheduled to go to six different pens, wherein two of the pens receive the same type of ration. In this example, truck number one must carry four different rations of a predetermined load weight. Since the truck can only carry one ration at a given time, the database will determine the feeding order to combine loads of like rations to the maximum capacity of the mixer. The feed loads are then delivered to the pens.

When a mixer driver is given a prescribed ration, he or she introduces each desired amount of each ingredient and mixes them until fully blended. The mixer driver then unloads the prescribed amount of ration to each selected pen. The time the driver allowed the ingredients to blend and the actual amount (by weight) delivered to a pen is recorded electronically and stored on the memory device located on the mixer. Alternatively, this information is radioed back to the farm computer.

While the stand-alone database works well for feed management on a single farm, difficulties arise when one wants to compare data for more than one farm, or if the farmer wants to allow an outside source to manage feed inventory. Data is specific to a single stand-alone database and cannot be transferred electronically to a different database that is not dedicated to a single data set, i.e. data from one farm.

Further, with a stand-alone system, the farmer still needs to manage the ordering of feed when supplies are low. One problem exists in that the timing of the feed order may not coincide with the supplier delivery schedule. This results in delayed shipments or higher delivery charges to the farmer. In addition, if several farmers simultaneously order a necessary ration ingredient from a supplier, the supplier may not be able to immediately fill the demand. Thus, there is a need for a system that allows feed suppliers to anticipate the farmer's demand for certain feed ingredients.

Periodically, the feed data can be compared to milk/meat production and prices, for determination of the effectiveness of particular rations for a given herd. However, because the local database can only store data for a single farm, a corporation owning more than one farm must reenter all pertinent data into a different spreadsheet to obtain comparison data or comprehensive data for all farms. This is time consuming and leaves room for error during data transfer.

Further, data regarding milk production, inventory, and the like must also be transferred to nutritionists and feed mills so that feed orders can be timely placed and rations adjusted, either to boost production or compensate for low inventory. This requires the farmer to send pertinent data to the nutritionist or feed mill either by hard copy or in an electronic format such as a spreadsheet. Unfortunately, electronic information is again specific to the stand-alone system, and cannot reside in a system with data for more than one farm. This forces the nutritionist or the feed mill to manually reenter the information in their own databases. Thus, there is a need for a system that allows direct electronic transfer of data.

In addition, unless the nutritionist visits frequently, the stand-alone system does not easily allow the nutritionist to adjust rations due to low supply of an ingredient or a change in diet. The farmer must carefully watch supplies and communicate any low rations to the nutritionist immediately. Thus, there is need for a system that can allow the nutritionist to automatically update supply and ration information without having to visit the farm or rely on farmer input.

As such, there exists a need for a system that allows the farmer to enter information into a local database and communicate that information to other databases. In addition, there exists a need for a system that allows the other databases to communicate with the local database on the farm. This two-way communication would allow increased productivity as farmers, suppliers, veterinarians and the like would be able to quickly and easily share information. This two-way communication would also allow an owner of multiple farms to quickly and easily manage each individual farm while also being able to tabulate all the information from all his or her farms.

### BRIEF SUMMARY OF THE INVENTION

To overcome these and other problems, the present invention provides a feed management system that facilitates two-way communication between a local farm database and a remote database located at a feed supplier, nutritionist's office, veterinarian or the like. Alternatively, two-way communication can also occur between a local database, a remote database, and a second remote database. This invention allows the farmer to further automate his feed operation. Data can be transferred to remote systems for analysis, the rations adjusted and supplies ordered, all without further input from the farmer. Specifically, the system can be used to determine rations on a pen-by-pen or farm by farm basis; determine inventory for single or multiple farms; verify that each herd is fed the prescribed amount of feed; provide a method to calculate production on a pen-by-pen or farm-by-farm basis, and to provide comparisons thereof; allow projections as to what feed will be needed based on current supplies, and allow adjustments to the herd diets on the same basis.

Specifically, farm specific information is entered into a first remote database. Necessary feed and production data relating to each animal herd are obtained by the farm, and sent electronically, such as via e-mail, from the local database to the first remote database. A service provider uses the remote database to analyze the necessary feed and production data and farm specific information to determine a new ration, veterinary protocol or feed supply order. The service provider uses the remote database to send direction regarding the analyzed data to the local database and/or a second remote database. The second remote database is operated by another service provider linked electronically to the local database. For example, a nutritionist at a first database may send ration information to a supplier at a second database. This allows rations or other directions relating to the care of the animals to be automatically ordered without input from the farm.

While the present invention is particularly useful for farms, other applications are possible, and references to use in animal farms should not be deemed to limit the application of the present invention. The present invention may be advantageously adapted for use where similar performance capabilities and characteristics are desired, i.e. vegetable farms or the like. These and other objects and advantages of the present invention will become apparent from the detailed description and claims.

### BRIEF DESCRIPTION OF THE SEVERAL VIEWS OF THE DRAWING

FIG. 1 shows a computer screen interface through which the user sets up an authorized communication link.

FIG. 2 shows a computer screen interface through which the user sets up email communication with remote databases.

FIG. 3 shows a computer screen displaying the interface through which a user may add new contacts to be included in communications.

FIG. 4 shows a computer screen interface through which a user of the remote database may select a particular farm in order to view or analyze farm specific information.

FIG. 5 shows a computer screen displaying the types of files that may be transferred between databases.

FIG. 6 shows a computer screen indicating a local database's receipt of new ration mix information from a remote database such as that of a nutritionist.

FIG. 7 shows a computer screen indicating a local database's receipt of new ration mix information from a remote database such as that of a dairy.

FIG. 8 shows a computer screen indicating that certain necessary data is missing, e.g., bulk density.

FIG. 9 shows a computer screen prompting the user to ensure that their database is connected to the Internet before sending data to another database.

FIG. 10 shows a computer screen interface through which the user may choose a specific database to send information.

FIG. 11 is a flow chart representing the method by which information may be gathered from sources such as a feed mixing truck, input into a local database, sent via email to a first remote database, and sent via email to a second remote database. Information may also be sent in the reverse order.

FIG. 12 is a flow chart representing the method by which information may be input into a local computer database and sent directly to a second remote database. Information may also be sent in the reverse order.

### DETAILED DESCRIPTION OF THE INVENTION

According to the invention, information or data is entered or input into a local database. This data or information can then be electronically transmitted to a remote location. The data or information can be analyzed at the remote location. Alternatively, the data or information can be electronically transmitted from the remote location to another remote location. In addition, information or data can be electronically transmitted from a remote location to the local database. This set of information or data can be analyzed versions of the data or information that was originally transmitted from the local database. This set of information or data can also be new information, new data, other information, revised data, or unaltered data.

According to the invention, a single remote database is used to collect data from several farms. Data is sent to the remote database from a local database over the Internet, such as via electronic mail (e-mail), file transfer (FTP), or any other electronic, secure information transfer method. For privacy reasons, an authorization code may be required to access and send information between the local farm database and the remote database. For example, identification numbers or security codes are preferably used to allow data transfer only between authorized parties and to uniquely identify the local farm database from which data is sent. The use of numbers or codes will prevent data from a first farm from being confused for data from a second farm. Further, this use will ensure confidentiality between farms.

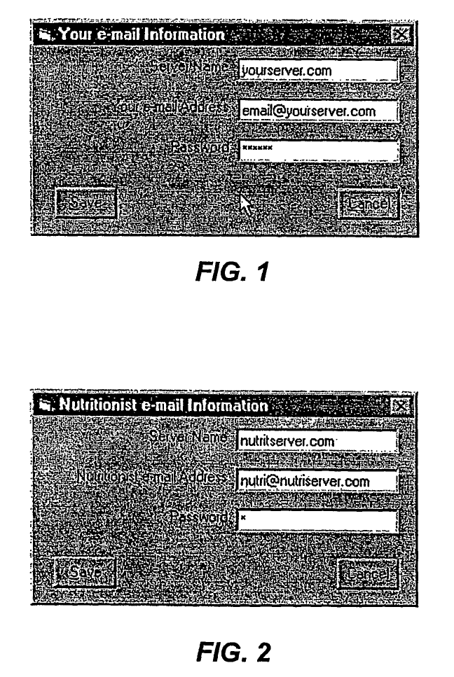

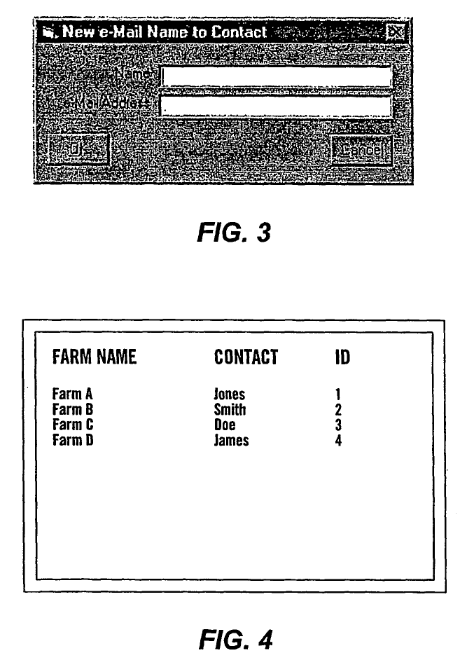

To initially set up the communication, authorizing information, such as server name, e-mail address and password, is input into the system. In each database, there may be additional e-mail addresses or user access information entered. A computer screen displaying the entry of such information is depicted in FIG. 1. For example, the local database may send specific information to a veterinarian, and other information to a nutritionist. A computer screen displaying the ability to send specific information to a specific person is depicted in FIG. 2.

In addition to the authorization information being set up as just described, information regarding each farm is entered into the remote database. This information includes, but is not limited to, ration ingredients used by each farm, farm specific rations, farm pen information, and the like. It may further include such information as the farm name, contact information, serial number of the local farm database (to uniquely identify the farm), and the farm contact information, which may include an e-mail address. This step is very much the same as setting up the blank local farm database for the first time. If desired, a remote database template can be electronically transmitted to a farm, customized by the farmer, and transmitted back to the remote database. A template differs from the blank database in that it can be set up within the remote database as a basis for all other local databases serviced. The result is a standard for entries such as ingredient names, pen types or any other element input into the database. This step is repeated for each farm added to the remote database.

As shown in FIG. 4, to select a particular farm, the user is presented with a list of available farms, each item in the list preferably including information such as the farm name, contact information, and identification number. To perform an analysis or view farm specific information, a farm may be selected from the list.

To receive data from a farm contact, a remote database user may first need to verify that a connection exists with the source such as a server or the like. The user can thus ensure that, if data is not received, it is not due to lack of connection between remote and local databases. Preferably, the remote database will indicate if no electronic messages have been received. The remote database user may send a verification of any data received.

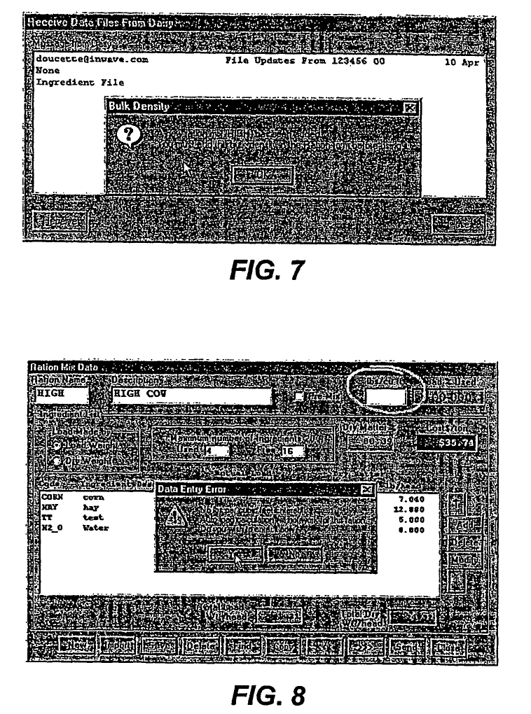

Once a data file is received from the farm database, any new ration information will be indicated. A computer screen displaying such a data file is shown in FIG. 7. If any necessary data is missing, e.g., bulk density, the remote database user may input the missing information, if known, or obtain the missing information from the farm by any suitable means. A computer screen displaying the ability to input missing information is shown in FIG. 8. Preferably, new feed rations should be prevented from being generated with the incomplete current ration information. Further, files may be deleted from the listing when the data is transferred from the local to the remote database so as to prevent data from being downloaded more than one time.

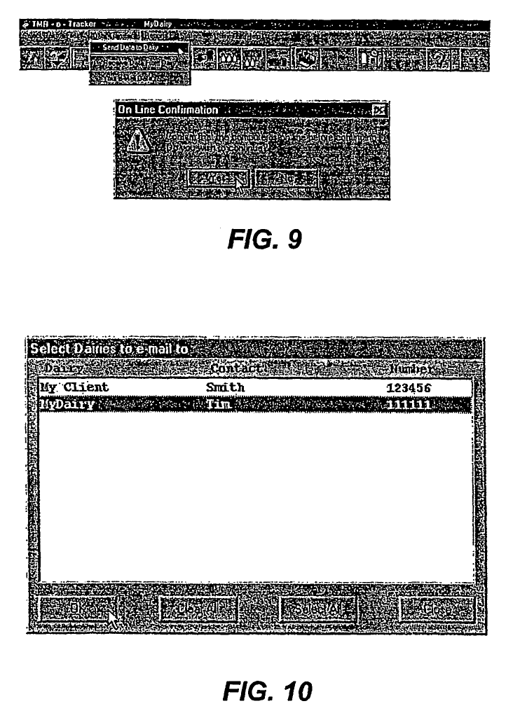

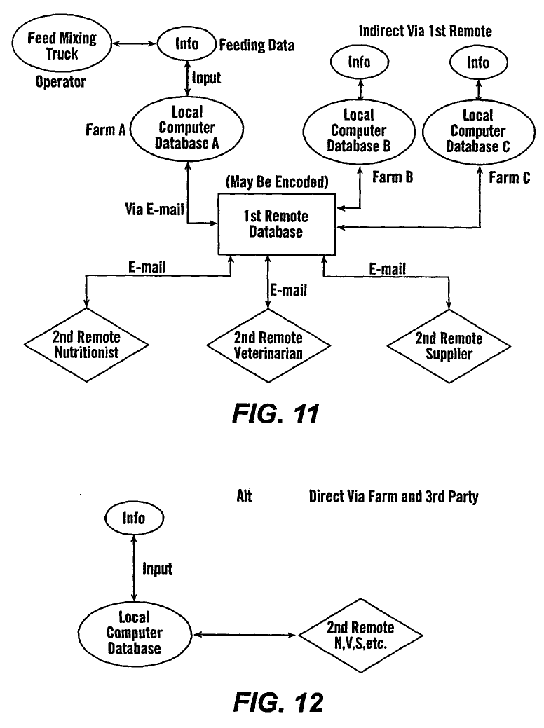

The invention also permits data to be sent back to the contact at the local database. This may occur once it has been confirmed that the remote database is connected to the Internet. A computer screen displaying a tool bar with the option to send data to a local database, and an on-line confirmation screen, are depicted in FIG. 9. The data will only go to a database having the unique farm identification number that corresponds to the data. A computer screen demonstrating the ability to send information to a specific remote database is depicted in FIG. 10. Preferably, the user of the remote database can attach a message to the new information, e.g., “Hello Client, We added a new ration called XYZ—density is 22.5 lbs/cu. ft.” However, messages are not required. When the information has been successfully sent, the invention preferably has the ability to create a message indicating such.

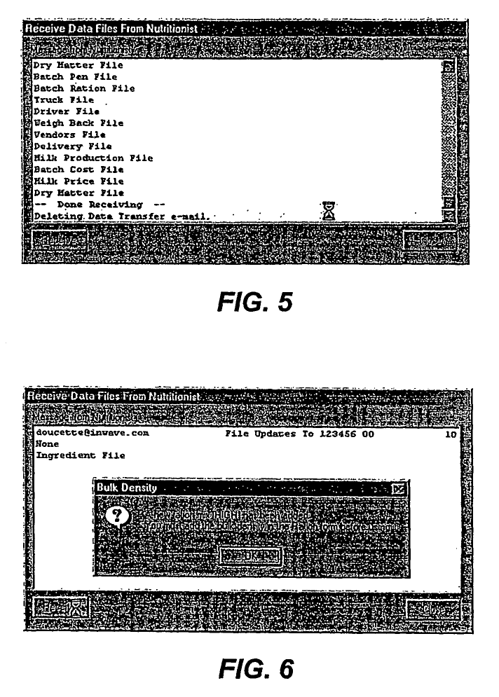

The types of files that may be transferred from each database to the other may include but are not limited to the following: dry matter, batch pen, batch ration, truck, driver, weigh back, vendors, delivery, milk production, batch cost, and milk price. A computer screen displaying some of the data files that may be transferred between databases is depicted in FIG. 5.

Once the remote and local databases are initially set up, the system can be used to achieve an array of goals. One goal is to determine new feed rations and inform the feed supplier of changes to the rations so that ordering of necessary ingredients can be made without the necessity of farmer input. Preferably, the feed ration data is sent via electronic information transfer from the farm local database to the remote database. This data may include the ingredient inventory levels, the ingredient level at which a reorder takes place, the milk/meat production per pen, milk/meat prices, and the cost of ingredients. This data is sent from the farm local database to the remote database. A nutritionist or the like uses the data already input at the remote database in conjunction with this new data received from the farm local database to determine the most cost effective rations for each pen. These new rations are sent back to the farm local database from the remote database via electronic transfer. A computer screen representing the receipt of such information is depicted in FIG. 6. The new rations are distributed to the feed mixing truck immediately. The new rations and current feed inventory are sent either from the farm local database to a supplier remote database, or directly from the first remote database to the supplier remote database. Oftentimes, the supplier employs the nutritionist and this last step is not necessary.

The advantages of the remote database system of the present invention are many. For example, feed orders can be completely automated. Inventory levels are sent to feed mills/suppliers so that ingredients may be reordered when the inventory becomes low. This benefits the mill/supplier as well as the farmer. Deliveries can be more effectively managed as delivery routes can be based on projected needs from actual farm usage.

Feeding data (i.e. rations per pen, mixing time etc.) can be accessed from the farmer's home or another remote site. Also, a nutritionist or other consultant can access this data without having to visit the farm or receiving electronic copies of the data via mail or the like. This person can then update feed rations depending on whether a particular ingredient is not available or low in supply, or if the dietary needs of the animals have changed due to weather, illness, poor production status, or the like.

The farm owner can receive updated rations from a nutritionist or an outside consultant/service provider directly into the local database. In addition, service providers can schedule a call to the farm to carry out any prescribed instructions without separate input from the farm. Thus, the farmer does not have to necessarily schedule appointments with veterinarians or the like, or upload or enter any information into the local database. This results in time savings and greater accuracy for ration mixes because the mixer operators can directly download the new ration information without having to receive instruction from another source.

The benefit to the nutritionist or consultant is that fewer on-farm visits are needed to receive farm data. Further, multiple farms can be tracked with a single database so that data between farms can be easily compared.

A farmer (or corporation etc.) that owns more than one farm can track each farm's inventory from a central location, review each farm's feeding record, receive commodities at the main farm and send updated inventory levels to all farms. All this can be accomplished without the requirement of visiting the farms. The farmer is free to run his or her farm from a remote location.

While the methods herein before described are effectively adapted to fulfill the aforesaid objects, it is to be understood that the invention is not intended to be limited to the specific preferred embodiments of feed and diet management set forth above. Rather, it is to be taken as including all reasonable equivalents to the subject matter of the appended claims.

We claim:

1. A method of processing data from farms, the method being implemented on a computer system and comprising the steps of:
(a) inputting information into a local database located on a farm;
(b) electronically transmitting selected data to a remote location;
(c) analyzing at least the selected data; and
(d) electronically transmitting data from the remote location to the local database.

2. The method of claim 1, wherein the data that is electronically transmitted from the remote location to a local database may be analyzed data, new information, new data, revised data, or unaltered data.

3. The method of claim 1, where said remote location is a mill, feed supplier, veterinarian, farm corporation, farm cooperative, nutritionist, or a farmer's home.

4. The method of claim 1, comprising the additional steps of:
(a) electronically transmitting at least selected data to a second remote database; and
(b) analyzing at least the selected data.

5. The method of claim 4, comprising the additional step of electronically transmitting data to a first remote database.

6. The method of claim 4, comprising the additional step of electronically transmitting data to a local database.

7. The method of claim 4, wherein second remote database is located at a mill, feed supplier, veterinarian, farm corporation, farm cooperative, nutritionist, or a farmer's home.

8. A method for processing feed-related data from farms having a local database, the method being implemented on a computer system and comprising the steps of:
(a) assigning an identification number to a local database for recognition by at least one remote database compatible therewith;
(b) storing information on the local database regarding the feeding and production of penned animals at the farm;
(c) electronically accessing at least selected data from the information from the local database to the at least one remote database compatible therewith, wherein the source of the selected data is identified by the identification number;
(d) analyzing the selected data obtained from the local database;

9. The method of claim 8 further comprising the step of electronically transmitting selected data to the local database having the identification number;

10. The method of claim 9 further comprising the step of electronically transmitting selected data to delivery vehicles.

11. The method of claim 8 further comprising the step of electronically transmitting selected data to delivery vehicles.

12. The method of claim 8, wherein the selected data relates to feed rations, animal production, farm costs, medical information, nutrition, health, market price of animal products, or type of animal.

13. The method of claim 8, wherein the remote database is located at a mill, feed supplier, veterinarian, farm corporation, farm cooperative, nutritionist, or a farmer's home.

14. The method of claim 8, further including the step of electronically transmitting selected data to at least one second remote database, wherein said second database is located at a mill, feed supplier, veterinarian, farm corporation, farm cooperative, nutritionist, or a farmer's home.

15. The method of claim 8, wherein the steps of electronically transmitting are performed using e-mail.

16. The method of claim 15, further including the step of setting up two-way e-mail communication between the local database and at least one remote database, the step comprising: inputting a server name, an e-mail address and a password on the local database and each at least one remote database.

17. The method of claim 15, further including downloading data contained in the e-mail and deleting the e-mail thereafter to avoid data from be entered onto the local database or the at least one remote database more than once.

18. The method of claim 8, wherein the identification number is a serial number that is unique to a local database.

19. A method for providing care or new feeding rations to herds of farm animals at a farm having a local database, comprising the steps of:
(a) entering farm specific information into a first remote database;
(b) obtaining necessary data relating to each animal herd;
(c) electronically sending the necessary data from the local database to the first remote database;
(d) using the remote database to analyze the necessary data to determine if medical care is needed or if animal feeding rations need adjustment; and
(e) sending electronically from the first remote database to the local database prescribed instructions relating to either adjusted animal feeding or medical care.

20. The method of claim 19 further including the step of sending the prescribed instructions via e-mail to a second service provider so that the prescribed instructions can be carried out without input from the farm.

21. The method of claim 19 further comprising the step of sending the data and prescribed instructions to a second remote database.

22. The method of claim 21 wherein said second remote database is located at a mill, feed supplier, veterinarian, farm corporation, farm cooperative, nutritionist, or a farmer's home.
